(19) United States
(12) Patent Application Publication
(10) Pub. No.: US 2006/0048060 A1
(43) Pub. Date: Mar. 2, 2006

(54) Intelligent personalization based on usage analysis

(76) Inventors: Julia Mohr, Edingen-Neckarhausen (DE); Michael Danninger, Landau (DE)

Correspondence Address: PERKINS COIE LLP, P.O. Box 2168, Menlo Park, CA, 94025-2168, US

(21) Appl. No.: 10/932,369

(22) Filed: Aug. 31, 2004

(51) Int. Cl. G06F 3/00

(52) U.S. Cl. 715/747; 715/745; 715/746; 715/788; 715/789; 715/709

(57) ABSTRACT

The present system provides a computer interface manager that allows the user to intelligently customize their personal interface with a computer application. The present invention provides an interface engine that enacts a plurality of algorithms that prompt and guide the user through the customization process. The interface management algorithms provide automatically generated pop-up menus and pull down menus that receive user inputs regarding the changes to be made to the interface. The user is therefore able to enhance their interface and therefore enhance their ability to process information using the computer application.

### TECHNICAL FIELD

The present invention relates to computer interfaces and more particularly, to a system and methods for allowing a computer interface to be intelligently personalized by the computer user.

### BACKGROUND OF THE INVENTION

As the use of computers to perform a larger variety of tasks increases, the need to operate and interface with computers and different software applications also increases. As a result, both the type and style of computer networks and the types and styles of software applications to exchange of information, continues to grow. This growth occurs not only in the number of computer networks, but also in their size, as evidenced by the expanding use of local area networks (LANs), wide area networks (WANs), enterprise-wide networks (which might include several WANs) and, ultimately, world-wide networks, such as the internet.

In order to aid and enhance the computer user's understanding and interaction with these numerous types of computers and programs, various application programs have been developed which display commonly used functions of the applications. Some of these applications may provide a graphical format in which to present information to the user. In other types of applications, the user may be presented with only text information regarding their interface with the computer. Another example of a computer application interface is found in the Microsoft Word program, which provides common functions such as “File”, “Edit”, and “View”, that may be activated by selecting the appropriate button.

The task of interfacing with a computer becomes increasingly difficult and burdensome to the operator as both the complexity and variety of interfaces increases. For computer applications that involve complex processes of any appreciable size, the utility of these graphical interface programs is inversely related to the size and complexity of the processes for which they are used. This complexity is due to the fact that the monitor screen becomes increasingly crowded as more icons or functions and the like are added to the display screen interface. Furthermore, these interfaces can increase exponentially, and their illustration can result in such a “busy” appearance on the screen that the information contained therein becomes incomprehensible.

It is often the case that a computer user's level of proficiency would be enhanced if their computer interface was more user friendly. The user commonly does not need to know about or use every possible tool available in a given application. Rather, the user may only be using a small portion of the tools or features available. In such a case, most or some of the information provided by an interface is of little value to the computer user. Standard software applications provide interfaces that generally are not customizable by the computer user. It is desirable, therefore, to provide an interface for a user which permits the operator to customize the displayed information in a manner which limits it to that which is particularly useful, and yet still provides the power and flexibility desired.

### SUMMARY OF THE INVENTION

An embodiment of the present invention provides a system and method for prompting and allowing a computer user to personalize their computer interface. Other embodiments of the present invention provide an interface manager that uses algorithms for automatically producing menus of choices to the user regarding functions provided in the interface. The user is then able to delete or add functions to enhance their interface. In addition to the automatic pop-up menus provided, the interface manager also allows for user activated menus to be selected. These menus allow the user to change and view statistics regarding their use and personalization of the interface. Within the personalization process the interface engine allows the user to view variants within the interface, show a usage analysis of the interface, and provide a preferences feature. The user is further able to set time periods and thresholds for prompting the interface engine to generate pop-up menus that query the user on specific features.

Another embodiment of the present invention also provides a computer system to enact the algorithms used in the interface engine. The exemplary computer system includes the interface engine, a processor, a display, a display controller and a memory. In still another embodiment of the present invention, the interface manager algorithms and processes are contained in programming code segments that enable the present invention to be used in the computer environment as described herein.

It will be appreciated that the present invention is described below using specific examples that are not intended to limit the invention. The systems and methodology may be applied to a broad range of other computer applications. Therefore these and other advantages of the present invention will become apparent to those skilled in the art upon a reading of the following detailed description and a study of the drawing figures.

### BRIEF DESCRIPTION OF THE DRAWINGS

FIG. 1 shows a screen shot of a user interface of an embodiment of the present invention;

FIG. 2 shows a screen shot of a pop-up menu provided by an embodiment of the present invention;

FIG. 2A shows a screen shot of a pop-up menu provided by an embodiment of the present invention;

FIG. 3 shows a screen shot of the user interface as modified by an embodiment of the present invention;

FIG. 4 shows a screen shot of a pull-down menu provided by an embodiment of the present invention;

FIG. 4A shows a screen shot of a variants feature provided by an embodiment of the present invention;

FIG. 5 shows a screen shot of a usage analysis feature provided by an embodiment of the present invention;

FIG. 6 shows a screen shot of a preferences feature provided by an embodiment of the present invention;

FIG. 7 is a flow diagram illustrating the interface engine process of an embodiment of the present invention;

FIG. 8 is a flow diagram illustrating the pop-up menu process of an embodiment of the present invention;

FIG. 9 is a flow diagram illustrating a personalization process of an embodiment of the present invention; and

FIG. 10 is a schematic diagram of the interface engine system of an embodiment of the present invention.

### DETAILED DESCRIPTION OF THE PREFERRED EMBODIMENT(S)

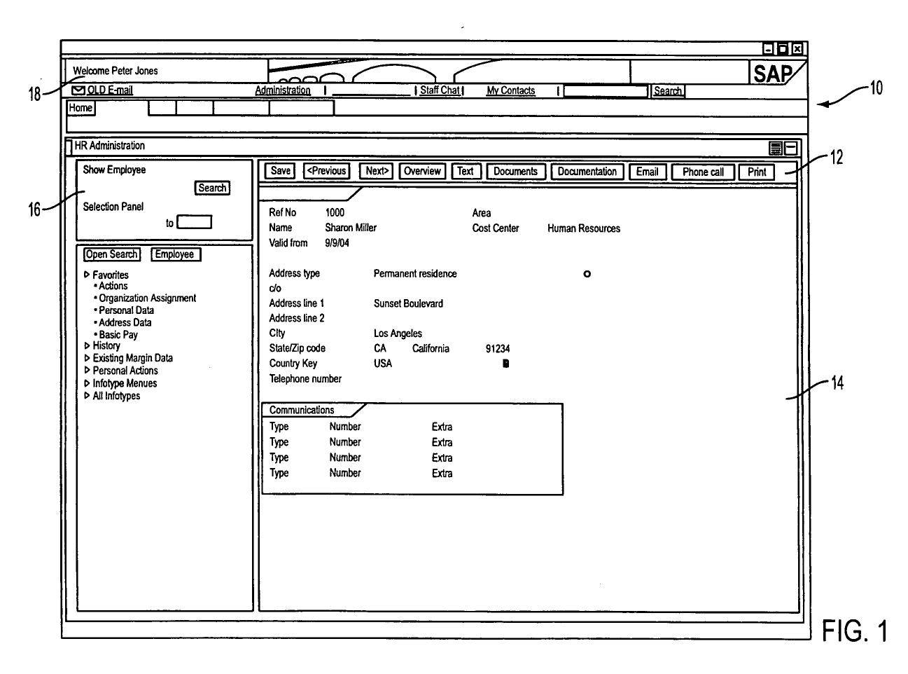

In one embodiment, the present invention provides a user interface engine that controls and enables an intelligent personalization of a computer interface. The present invention preferably uses a plurality of different algorithms to query the user and receive their feedback regarding features contained in the interface. Various exemplary embodiments of the present system and methods are described below with reference to FIGS. 1-10.

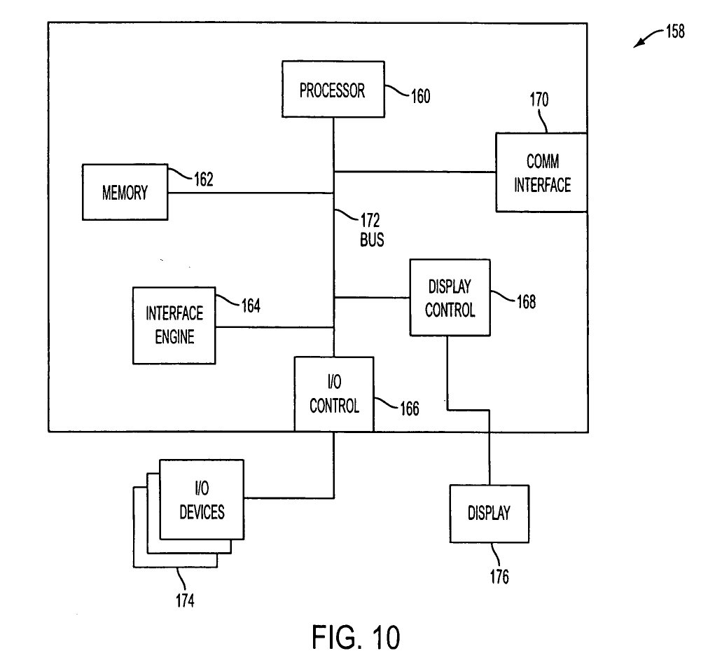

FIG. 1 shows a screen shot 10 of a user interface provided by one embodiment of the present invention. By “screen shot” it is meant that an image displayed on a screen of a computer or the like at a particular point in time is reproduced as a figure. In this example, a Human Resources or “HR” application interface is shown. The user interface screen 10 would be dependent upon the type of application running, for example an employee in the accounting department has a different type of interface screen that contains features relating to accounting duties. The user interface includes a tool bar of features 12 that are commonly employed in a HR administrator environment. These features include for example, the functions of “Save”, “Previous”, “Next”, “Documents”, “Documentation”, “E-Mail”, “Phone Call”, and “Print”. The interface further contains a main work screen 14, and other application specific windows 16. The name of the computer user 18 is also shown on the personalized interface, in this example the user is Peter Jones. The user interacts with the interface through the use of a personal computer for example, that would contain standard features such as a monitor for viewing data, a keyboard and mouse for entering data, and a microprocessor for running the application software programs. The computer system and means for supporting and enacting the present invention is described in more detail with reference to FIG. 10.

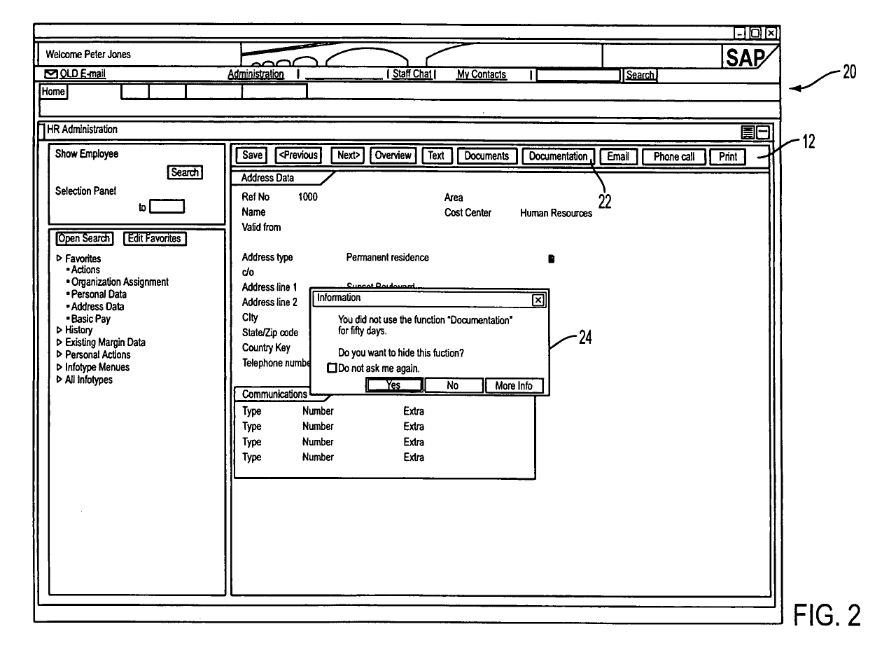

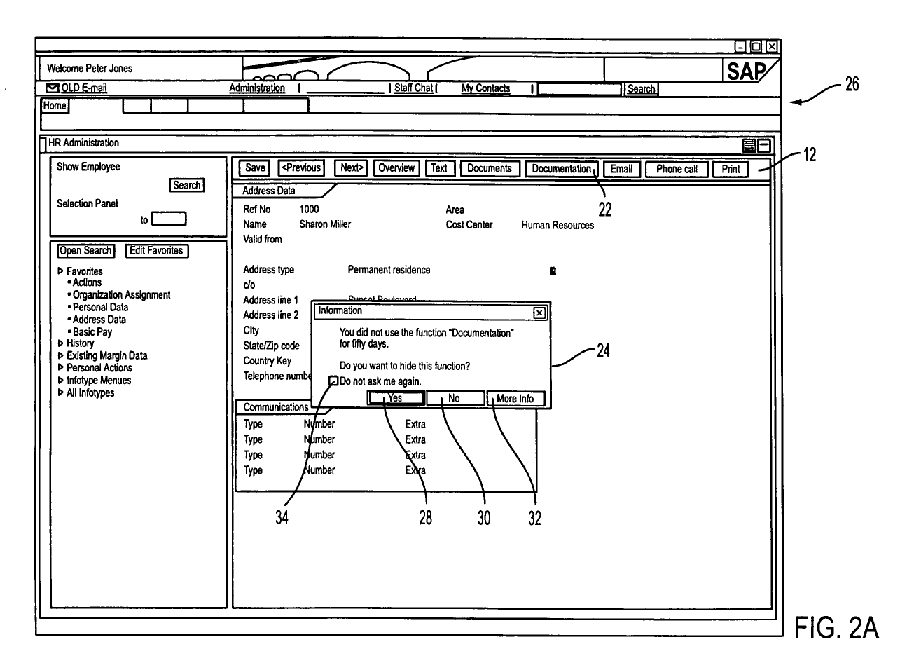

A screen shot 20 shown in FIG. 2 shows an example of a method of managing a user interface provided by an embodiment of the present invention. In this example, a pop-up menu 24 is automatically displayed to the user. The information related to the user is the fact that “the Documentation function has not been used in 50 days”. The information regarding the use of the application functions is stored and accessed by the interface engine. The “Documentation” function button 22 is currently present and displayed on the toolbar 12. As will be described in greater detail below, the interface engine has a predetermined threshold time period, (50 days) wherein if the time period passes without the user enacting an existing function, the user is queried as to whether or not the function button should be removed or hidden from the interface. Once the pop-up menu 24 is presented to the user, the interface engine waits for the user selection, which will determine the exact nature of the change, or if the interface is to be changed.

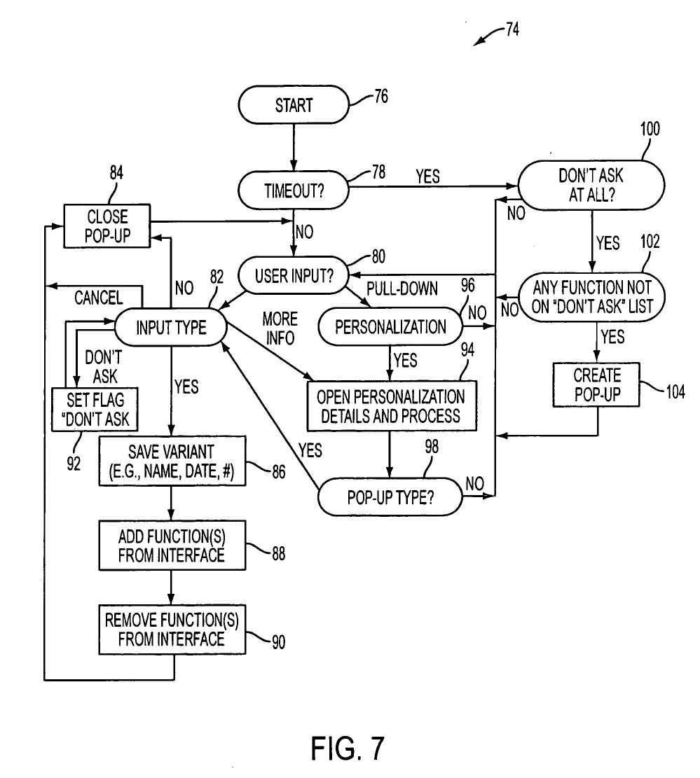

The screen shot 26 shown in FIG. 2A shows an example of a user responding and interacting with the pop-up menu 24. In this example, a pop-up menu 24 provides choice buttons “Yes” 28, “No” 30, and “More Info” 32, in which to respond to the query “Do you want to hide this function?” The user is also able to check a box 34, and request that this question is not asked again. The “Documentation” function button 22 is currently present and displayed on the toolbar 12. The user's selection to these questions prompts the interface engine to proceed with the user's selection and guide the user to intelligently customize their interface. These methods of interface customization are shown in more detail in FIGS. 7-9.

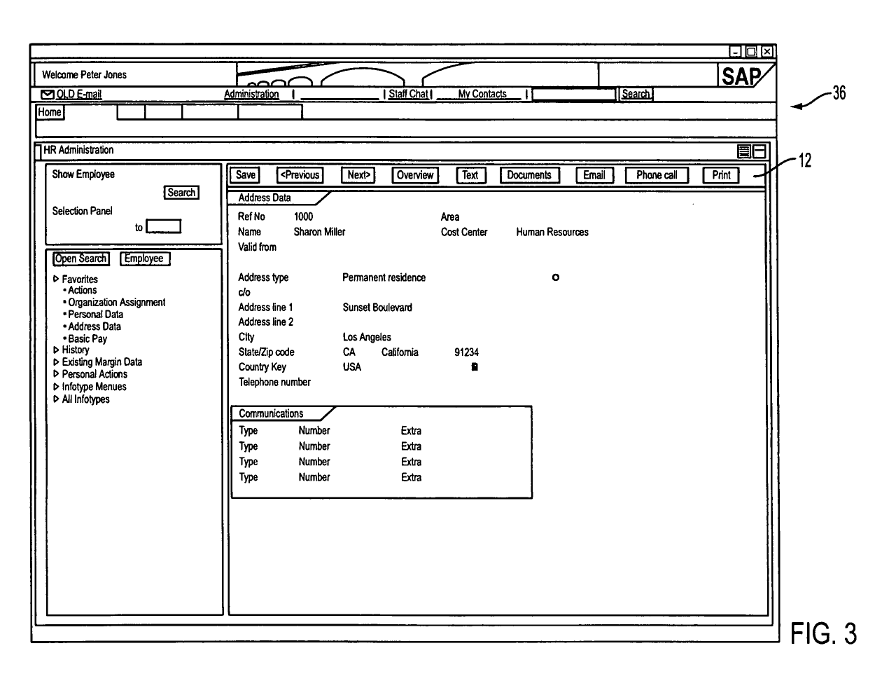

FIG. 3 shows a screen shot 36 of an example of the interface after the user has selected “Yes” as prompted by the menu in FIG. 2A. The toolbar 12 now does not contain a “Documentation” button, as it has been removed by the interface engine. In this manner, the interface manager automatically prompts the user to customize and enhance their personal interface. In addition to automatic prompting, the user may also actively choose to personalize and change their interface as described below. When the user chooses “No” or “More Info” in the menu shown in FIG. 2A, the interface is not automatically changed.

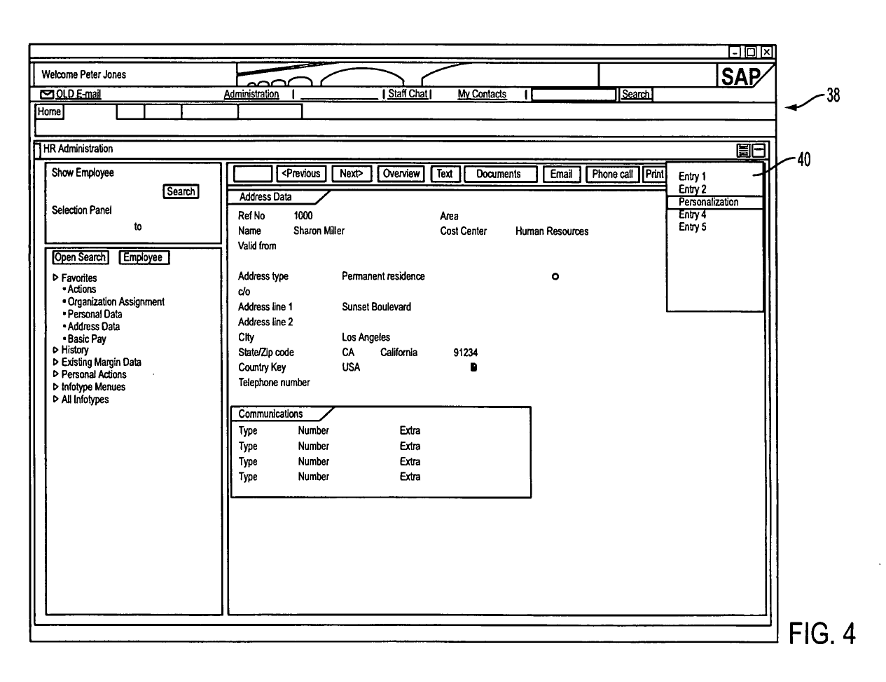

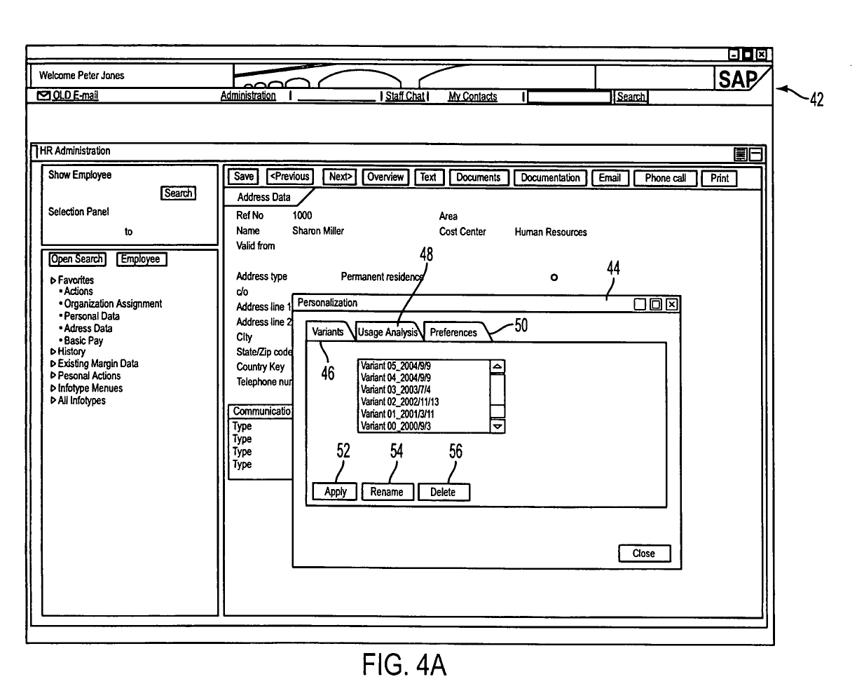

FIG. 4 shows another example of a screen shot 38 provided by the interface engine manager of one embodiment of the present invention. In this screen shot of the interface 38, a drop-down menu of choices 40 is actively selected by the user. In this example the 5 choices of the drop-down menu 40 are “Entry 1”, “Entry 2”, “Personalization”, “Entry 4”, and “Entry 5”. FIG. 4 also shows that after the desired functions of the interface are changed, the other features of the interface remain as they are.

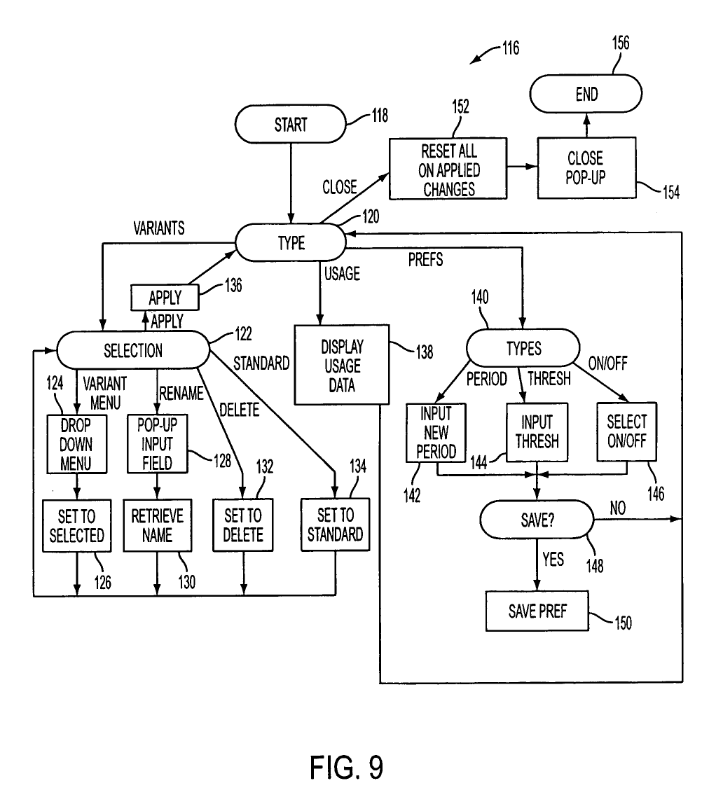

FIG. 4A shows a screen shot 42 that contains a menu 44 relating to the “Personalization” choice selected in FIG. 4. Included in this menu 44 are tabs for “Variants” 46, “Usage Analysis” 48 and “Preferences” 50. In this screen shot, the “Variants” tab is highlighted which allows the user to select from the different variants tracked by the interface engine. Examples of variants include name, date etc. Also contained in menu 44 are buttons 52, 54 and 56 which enact the choices “Apply”, “Rename” and “Delete” which will be described in greater detail with reference to FIG. 9. These provided choices allow the user to modify the variants of the interface. These choices further allow for a quick reset of the interface to a “standard” interface if desired.

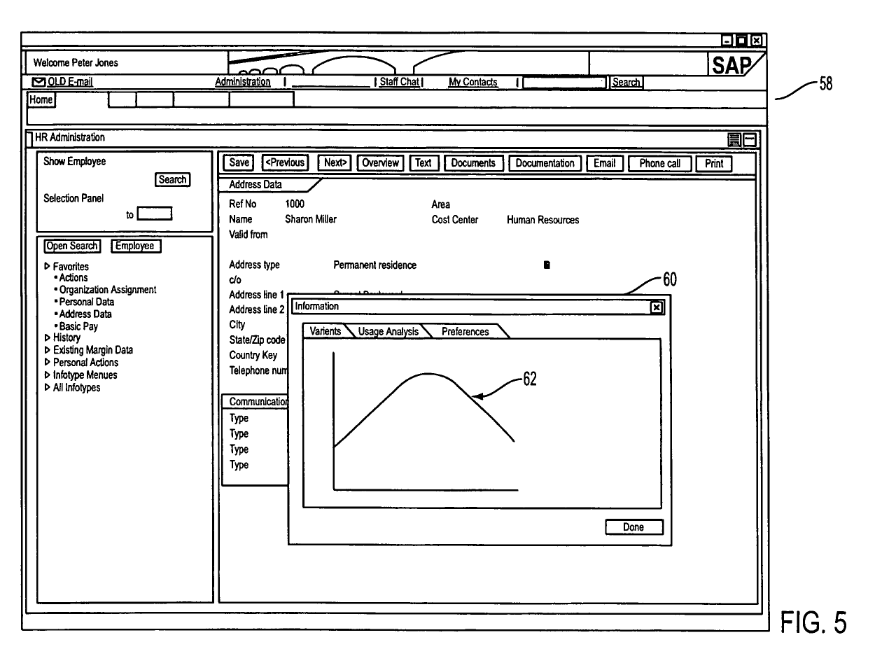

FIG. 5 shows another user interface screen shot 58 provided by an embodiment of the present system. In this example, under the “Personalization” feature, the “Usage Analysis” is selected in the window 60. A graph 62 showing the usage of specific features is displayed. This information is provided to aid the computer user in their selection and determination of what features in the interface are important. U.S. patent application Ser. No. 10/999,999, attorney docket number 42841-8016.US01, filed concurrently on Aug. 15, 2004, the complete contents of which are herein incorporated by reference, contains details relating to the “Usage Analysis” processes. The usage analysis informs the user to become aware of how they use their interface, which enables further intelligent customization of the interface itself.

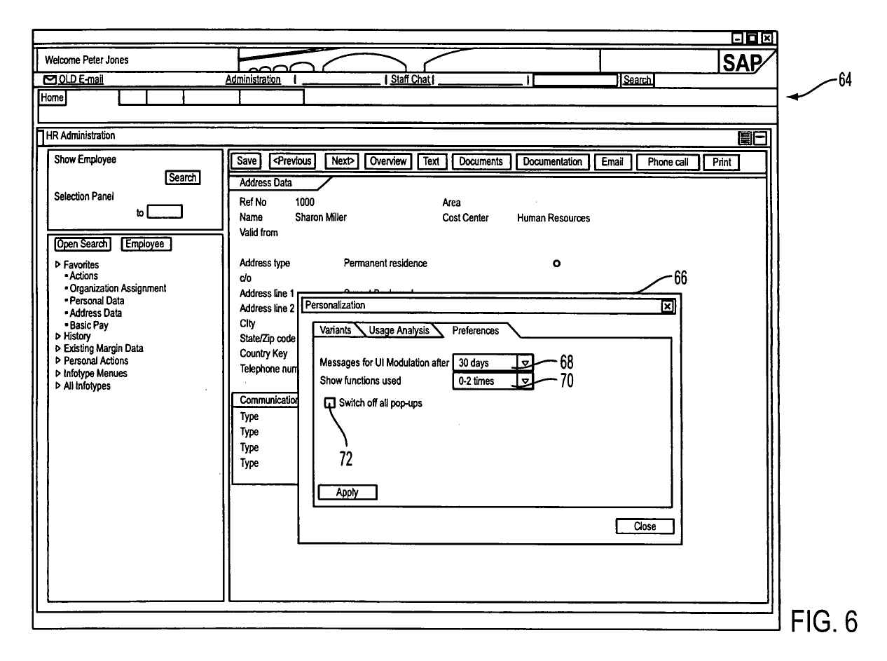

FIG. 6 shows a screen shot 64 showing the “Preferences” selection highlighted within the “Personalization” functions as contained in window 66. This menu 66 allows a user to change the predetermined time period 68 that automatically generates pop-up menus. The user is also able to view functions that are used beneath a predetermined threshold 70. By checking the box 72, the user may select to have all pop-up menus be switched off and therefore not generated and displayed to the user. These time periods 68 and thresholds 70 as set by the user, are then employed by the interface engine to manage the interface customization process. FIG. 9 further illustrates the details of how the interface engine proceeds with the inputs from the menu shown in FIG. 6.

FIG. 7 is a flow diagram illustrating the steps 74 enacted by an embodiment of the user interface engine that allows the user to intelligently personalize their interface. This exemplary interface management algorithm 74 is enabled by the interface engine and computer system as described in FIG. 10. The process starts in step 76 and then in step 78 a “Timeout” condition is determined. The “Timeout” or predetermined time period is set by the user. If the answer is “No” in step 78, the process continues with step 80 with the interface engine receiving the user input. If the user input is from a pop-up menu, step 82 is enacted and an input type is determined. The four possible user responses to this menu, asking the question “Do you want to hide this function?” are “Yes”, “No”, “More Info” and “Don't Ask Me Again”. If the user response is “No”, the interface engine closes the pop-up menu in step 84 and awaits further user input in step 80. A “No” answer therefore does not change the user interface. In response to a “Yes” answer in step 82, a variant such as a name or date is saved in step 86. Steps 88 and 90 respectively then add and remove any desired functions from the interface. The process then closes the pop-up menu in step 84 and returns to step 80 and awaits further user input. If the user input to the pop-up menu is “Don't ask me again”, step 92 is enacted where a “Don't ask” flag is set and stored by the interface engine. The process 74 then returns back to step 82 and awaits another input type. A user may also choose to simply cancel the pop-up menu, enacting step 84. If the user selects “More Info” a personalization process and details are opened as in step 94 as will be subsequently described.

If the user input is a pull-down menu in step 80, the process proceeds to step 96 and it is determined if a “Personalization” process is enacted. If “Yes”, then the personalization details and process is opened in step 94. In step 98 it is determined if a pop-up menu is displayed to the user. If the answer is “Yes” in step 98, the process 74 refers back to step 82 and the process proceeds as described above. If there is no pop-up menu the process returns to step 80. If the timeout answer is “YES” in step 78, the process proceeds to step 100 where it is determined if the user has input “Don't ask at all?” If “Yes”, the interface engine determines if there is any function not on the “Don't ask” list in step 102. If there is a function on the list, “Yes” to step 100, then a pop-up menu with the functions on the list is created in step 104. If the answer is “No” in steps 100 or 102 the process returns to step 80. This continuous process allows the user to intelligently personalize their computer interface as prompted and controlled by the interface engine.

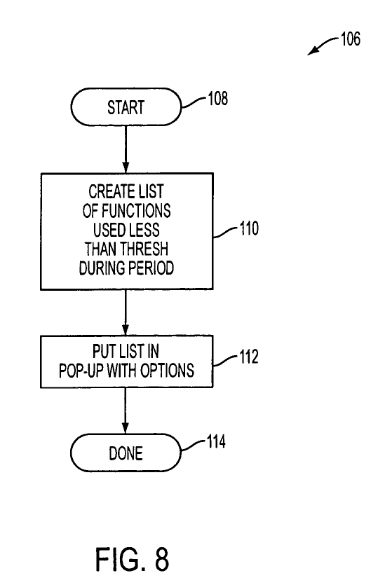

FIG. 8 is a flow diagram illustrating in greater detail, the steps 106 enacted in the searching process step 104 as shown in FIG. 7. This exemplary process starts in step 108 and then proceeds to step 110 by creating a list of functions that have been used less than a threshold during the predetermined period. This list of functions is then put into a pop-up menu with the appropriate options in step 112. This process is then finished in step 114 and the process returns to the algorithm as described in FIG. 7. As described above, the threshold of the number of uses and the predetermined time period are adjustable by the user. These pop-up menus are controlled and created by the interface engine working with the processor and display controller.

FIG. 9 is a flow diagram illustrating in greater detail, the steps 116 enacted in the personalization process step 94 as shown in FIG. 7. This exemplary process would begin from the “Personalization” selection on a pull-down menu. The process 116 starts in step 118 and then proceeds to step 120 where a user input “Type” is determined. These “Types” are “Variants”, “Usage Analysis” and “Preferences” as previously described. If “Variants” is selected in step 120, then the interface engine enacts step 122. In step 122 the type of user “Selection” is determined from the choices available in the menu. In step 124 a user may select from the “Variant” menu followed by set to be selected in step 126. If in step 122 a user selects the “Rename” button, a pop-up menu is displayed in step 128, followed by step 130 where the name is retrieved by the interface engine. In step 122 if the user selects “Delete”, then step 132 is enacted to delete the desired function. If the selection is “Standard” in step 122, step 134 resets the interface back to it's standard presentation. If the “Apply” button is selected by the user in step 122, step 136 is enacted where the selected variant is applied to the interface. The process then returns to step 120.

If the “Type” is determined to be “Usage” in step 120, the usage analysis data is displayed in step 138 and the process returns to step 120. If “Preferences” is highlighted in step 120, the process refers to step 140 where a further “Type” is determined as shown in FIG. 6. These “Types” of preferences determined in step 140 are “period”, “threshold” and “On/Off”. If the “Type” is period, then the process enacts step 103 where the user may input a new threshold time period to be used by the interface engine. If the “Type” is threshold, a new threshold is input in step 144. If an on/off selection is made, step 146 is enabled. After steps 142-146 the user is asked to “Save” any of the changes made in step 148. In step 150 the changes are saved when the answer is YES. If the answer in step 148 is no, the process returns to step 120 and awaits a new “Type” input. If the “Type” is close in step 120, step 152 is enacted which resets all of the applied user changes to the interface. The pop-up is then closed in step 154 and then the process is finished in step 156. The above exemplary algorithms guide and prompt the user to quickly and intelligently customize their personal interface. The user selected changes to the interface using the above methods are immediately enacted by the interface engine. Once the changes to the interface are incorporated, the user may then proceed to interact with any application program with the new interface.

As will be subsequently described with reference to FIG. 10, the interface engine allows a user to manage their interface for any type of application. The present system and screen shots as shown above, would therefore be controlled by programmed computer code segments as contained in FIG. 10. The process and methods of the interface engine are also contained in application Ser. No. 10/999,999, attorney docket number 42841-8016.US01, filed concurrently on Aug. 15, 2004, the complete contents of which are herein incorporated by reference.

FIG. 10 is a schematic diagram of an embodiment of a computer system 158 that embodies the means used to support the interface engine and the methods for managing a user interface as described above. The system 158 is capable of running conventional application programs such as the HR application described in FIG. 1. The exemplary computer system 158 may interface to external systems through the modem or network interface 170. It will be appreciated that the modem or network interface 170 can be considered to be part of the computer system 158. This interface 170 can be an analog modem, ISDN modem, cable modem, token ring interface, satellite transmission interface (e.g. “Direct PC”), or other interfaces for coupling a computer system to other computer systems.

The exemplary computer system 158 includes a processor 160, which can be a conventional microprocessor such as an Intel Pentium microprocessor or Motorola Power PC microprocessor. Memory 162 is coupled to the processor 160 by a bus 172. Memory 162 can be dynamic random access memory (DRAM) and can also include static RAM (SRAM). The bus 172 couples the processor 160 to the memory 162, to the interface engine 164, to display controller 168, and to the input/output (I/O) controller 166. The processor 160 and the interface engine 164 work together to enable and enact the exemplary methods of the present invention. The algorithms and processes of the interface manager would be contained in computer programmed code segments as is conventional. As described above the interface engine 164 provides an interface usage monitor that determines the usage over time by a user of the functions of a user interface. The engine 164 further provides an inquiry interface including a pop-up window inquiring of the user whether a function should be removed from the interface. The inquiry interface is then responsive to a user inquiry command developed by the usage monitor, and an interface reconfigurator.

The display controller 168 controls the display device 176 from instructions received from the interface engine 164 to provide the exemplary interactive menus as shown in FIGS. 2-6. The input/output devices 174 can include a keyboard, disk drives, printers, a scanner, and other input and output devices, including a mouse or other pointing device. The display controller 168 and the I/O controller 166 can be implemented with conventional well-known technology to provide the customized user interface.

The non-volatile storage of data into memory 162 is often a magnetic hard disk, an optical disk, or another form of storage for large amounts of data. Some of this data is often written, by a direct memory access process, into memory 162 during execution of software in the computer system 158. One of skill in the art will immediately recognize that the terms “machine-readable medium” or “computer-readable medium” includes any type of storage device that is accessible by the processor 160 and also encompasses a carrier wave that encodes a data signal.

The exemplary computer system 158 is one example of many possible computer systems that have different architectures. For example, personal computers based on an Intel microprocessor, often have multiple buses, one of which can be an input/output (I/O) bus for the peripherals and one that directly connects the processor 160 and the memory 162 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 162 for execution by the processor 160. A Web TV system, which is known in the art, is also considered to be a computer system according to this embodiment, but it may lack some of the features shown in FIG. 10, such as certain input or output devices. A typical computer system will usually include at least a processor, memory, and a bus coupling the memory to the processor.

In addition to the algorithms of the present invention, the computer system 158 is controlled by operating system software which includes a file management system, such as a disk operating system, which is part of the operating system software. One example of an operating system software with its associated file management system software is the family of operating systems known as Windows® from Microsoft Corporation of Redmond, Wash., and their associated file management systems. Another example of an operating system software with its associated file management system software is the LINUX operating system and its associated file management system. The file management system is typically stored in the memory 162 and causes the processor 160 to execute the various acts required by the operating system to input and output data and to store data in memory, including storing files on the memory 162.

Some portions of the detailed description relating to the exemplary interface engine 164 have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments also relate to the apparatus for performing the operations herein. This apparatus may be specially constructed for the required purposes, or it may comprise a general purpose computer selectively activated or reconfigured by a computer program stored in the computer. Such a computer program may be stored (embodied) in a computer (machine) readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein relating to the exemplary interface engine are not inherently related to any particular computer or other apparatus. Various general purpose systems may be used with programs in accordance with the teachings herein, or it may prove convenient to construct more specialized apparatus to perform the required method steps. In addition, the present invention is not described with reference to any particular programming language, and various embodiments may thus be implemented using a variety of programming languages.

The exemplary embodiments of the present invention therefore provide a system and methods for prompting and allowing a computer user to intelligently personalize their computer interface. The exemplary interface manager enacts algorithms with the interface engine for automatically producing menus of choices to the user regarding functions provided in the interface. The user is then able to delete or add functions as desired in order to enhance their interface. In addition to the automatic pop-up menus provided, the interface manager also allows for user activated menus to be selected. These menus allow the user to change and view statistics regarding their use and personalization of the interface. Other embodiments of the present invention also allow the user to quickly reset or return to a standard interface if desired. The personalization features of the present invention allow the user to statistics of their use which may be helpful in making further revisions to the interface. As described above, the user is further able to set time periods and thresholds for prompting the interface engine to generate pop-up menus that query the user on specific features, to further enhance the interface managing process.

One skilled in the art will appreciate that although specific embodiments of the communications system have been described for purposes of illustration, various modifications can be made without deviating from the spirit and scope of the present invention. For example, the present invention may be applied to many different types of databases, systems and application programs. Accordingly, the invention is described by the appended claims.

What is claimed is:

1. A method for managing a user interface comprising:
asking a user if at least one function of a user interface should be removed;
and removing said at least one function from said user interface if said user indicates that it should be removed.

2. A method for managing a user interface as recited in claim 1 further comprising:
determining that it is time to ask said user whether said at least one function of said user interface should be removed.

3. A method for managing a user interface as recited in claim 2 wherein determining that it is time to ask occurs when said at least one function has been used less than a threshold amount during a predetermined timeout period.

4. A method for managing a user interface as recited in claim 3 wherein determining that it is time to ask further involves a determination of whether said user has requested not to be asked with respect to at least one of a specified function, a set of specified functions, and all functions.

5. A method for managing a user interface as recited in claim 3 wherein removing said at least one function includes hiding said at least one function.

6. A method for managing a user interface as recited in claim 3 wherein a plurality of functions are removed.

7. A method for managing a user interface as recited in claim 3 further comprising:
opening a menu at said user's request providing at least one of a variants display, a usage analysis display, and a preference display.

8. A method for managing a user interface as recited in claim 7 wherein said variants display permits at least one of: choosing a previous version of said user interface, setting said user interface to a standard configuration, renaming a variant, and deleting a variant.

9. A method for managing a user interface as recited in claim 7 wherein said usage analysis display includes at least one of a graph, a chart, and a table.

10. A method for managing a user interface as recited in claim 7 wherein said preference display permits the changing of at least one of a time period, a threshold, and an enable/disable function.

11. A user interface manager comprising:
means for asking a user if at least one function of a user interface should be removed; and
means for removing said at least one function from said user interface if said user indicates that it should be removed.

12. A user interface manager as recited in claim 11 further comprising:
means for determining that it is time to ask said user whether said at least one function of said user interface should be removed.

13. A user interface manager as recited in claim 12 wherein said means for determining determines that is time to ask when said at least one function has been used less than a threshold amount during a predetermined timeout period.

14. A user interface manager as recited in claim 13 wherein said means for determining that it is time to ask includes means for determining whether said user has requested not to be asked with respect to at least one of a specified function, a set of specified functions, and all functions.

15. A user interface manager as recited in claim 13 wherein said means for removing said at least one function hides said at least one function.

16. A user interface manager as recited in claim 13 wherein said means for removing said at least one function removes a plurality of functions.

17. A method for managing a user interface as recited in claim 13 further comprising:
means for opening a menu at said user's request providing at least one of a variants display, a usage analysis display, and a preference display.

18. A user interface manager comprising:
a usage monitor determining the usage over time by a user of at least one function of a user interface;
an inquiry interface including a pop-up window inquiring of said user whether said at least one function should be removed from said interface, said inquiry interface being responsive to a user inquiry command developed by said usage monitor; and
an interface reconfigurator including an interface generator providing a reconfigured interface for said user without said at least one function.

19. A user interface manager as recited in claim 18 wherein said usage monitor further includes a timer and a function usage log, wherein said usage monitor develops said user inquiry command when said timer indicates that the time is appropriate and when at least one function on said function usage log has been used less than a threshold amount.

20. An interface manager as recited in claim 19 where said usage monitor is disabled from producing said user inquiry command with respect to at least one function by a don't ask flag for that function.
